(19) United States
(12) Patent Application Publication
(10) Pub. No.: US 2009/0113697 A1
(43) Pub. Date: May 7, 2009

(54) MANUFACTURING METHOD FOR BATTERY INCLUDING ELECTRODE ASSEMBLY FORMED BY WINDING

(75) Inventors: Shinji YAMAMOTO, Osaka (JP); Tomoyuki SHOSE, Osaka (JP); Kanji URUSHIHARA, Osaka (JP); Naoki TERADA, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 11/928,811

(22) Filed: Oct. 30, 2007

(30) Foreign Application Priority Data
Oct. 30, 2006 (JP) 2006-294643

(51) Int. Cl. H01M 4/82

(52) U.S. Cl. 29/623.1

(57) ABSTRACT

A manufacturing method for a battery, including the steps of: preparing a positive electrode plate and a negative electrode plate which are both belt-like; performing a curving work onto an end of at least one of the positive electrode plate and the negative electrode plate so that the end has a curvature, the end being located in a longitudinal direction of the plate; and after performing the curving work, performing a winding work by winding the positive electrode plate and the negative electrode plate with a separator there between all together to produce an electrode assembly. In the winding step, the winding work is performed such that the end having the curvature is wound last in the winding work and such that the curvature curves toward an internal side of the electrode assembly.

### BACKGROUND OF THE INVENTION

(1) Field of the Invention

The present invention relates to a manufacturing method for a battery that includes an electrode assembly formed by winding electrode plates, and especially to a technology for processing an end of a plate to wind.

(2) Description of the Related Art

In recent years, batteries are widely used as the power source of mobile devices that are typified by the mobile telephone and PDA (Personal Digital Assistant). The batteries to be used as the power source of such mobile devices are required to have higher output power or capacity while the mobile devices become smaller-sized and more useful.

As the means for increasing the output power of batteries, developed is a technology for making thinner both the positive and negative electrodes that are wound to be the electrode assembly. By reducing the thickness of the electrode plates to be wound, it is possible to increase the length of the positive and negative electrodes and thus to expand the area of surfaces of both electrode plates facing each other, for the same volume of the battery. Accordingly, with such a structure, it is possible to increase the responsiveness of the electrode assembly, and increase the output power of the battery.

However, when the electrode plates are made thinner and longer as described above, the volume ratio of the electrode plate core to the electrode plate increases. The electrode plate core in the electrode plate does not contribute to the battery capacity. As a result, there may be a case where the battery capacity is not increased even if the electrode plates are made thinner and longer.

Japanese Patent Application Publication No. 2004-311349 proposes a technology for solving the above-mentioned problem. That is to say, contrary to the above-described technology, it proposes to make the positive and negative electrode plates thicker so that the volume ratio of the electrode plate core to the electrode plate becomes smaller in volume. It is thought that this method can increase the density and amount of the active material filled in the electrode plate, and thereby increase the battery capacity as a whole.

However, the stiffness of the electrode plates becomes stronger when the electrode plates are made thicker to increase the density and amount of the active material. When the stiffness of the electrode plates becomes stronger, a “popping-away” phenomenon occurs in which the end of an electrode plate that is wound last pops away from the internal separator, not fitting with the arc of the winding. More specifically, as shown in FIG. 1, in an electrode plate 91 that is strong in stiffness since it has been made thicker, an end 91a, the end of the winding, pops away from the surface of an internal separator 93.

The “popping-away” phenomenon of the end 91a of the electrode plate occurs because the restoring force (the force of the spring back) increases as the electrode plate is made thicker. The popping-away of the end 91a of the electrode plate results in the increase of the outer diameter of an electrode assembly 90. This may make it difficult to insert the electrode assembly 90 into the outer package. Accordingly, the popping-away of the end 91a of the electrode plate may lead to the decrease in the manufacturing yield.

### SUMMARY OF THE INVENTION

The object of the present invention is therefore to provide a manufacturing method for a battery for achieving a high capacity of the battery by winding the electrode plates to have high density, and achieving a manufacturing yield by restricting the outer diameter of the electrode assembly.

One aspect of the present invention pertains to a manufacturing method for a battery, comprising the steps of: preparing a positive electrode plate and a negative electrode plate which are both belt-like; performing a curving work onto an end of at least one of the positive electrode plate and the negative electrode plate so that the end has a curvature, the end being located in a longitudinal direction of the plate; and after performing the curving work, performing a winding work by winding the positive electrode plate and the negative electrode plate with a separator there between all together to produce an electrode assembly, wherein in the winding step, the winding work is performed such that the end having the curvature is wound last in the winding work and such that the curvature curves toward an internal side of the electrode assembly.

In the above-stated battery manufacturing method, an end of at least one of the positive and negative electrodes is subjected to the curving work. After the curving work, the winding work is performed such that the end having the curvature is wound last in the winding work and such that the curvature curves toward an internal side of the electrode assembly.

With the above-described steps of the battery manufacturing method, occurrence of the popping-away phenomenon is restricted at the end of the winding of the electrode plate. Accordingly, the battery manufacturing method according to the aspect of the invention makes it possible to manufacture an electrode assembly that is easy to insert into the outer package even if the electrode plates are wound to have high density.

Thus the battery manufacturing method according to the aspect of the invention achieves a high capacity of the battery by winding the electrode plates to have high density, and achieves a manufacturing yield by restricting the outer diameter of the electrode assembly. It should be noted here that, although the end of the electrode plate may be bent at an acute angle, it is preferable that the end is curved so that the electrode assembly is housed into the outer package in an excellent manner.

The above-stated battery manufacturing method may be varied such that, in the electrode plate preparing step, an electrode plate whose core part is filled with an active material is prepared as the positive electrode plate, and in the curving step, the curving work is performed onto an end of the positive electrode plate. It should be noted here that in the nonaqueous electrolyte battery typified by the lithium battery, the negative electrode plate is lower than the positive electrode plate in stiffness. In view of the difference in stiffness between the positive electrode plate and the negative electrode plate, to restrict the occurrence of popping-away phenomenon at the end of the electrode plate in the electrode assembly, it is thought to be more effective to subject the end of the positive electrode plate, which has higher stiffness, to the curving work.

The above-stated battery manufacturing method may be varied such that a forming die used in the curving step has a curvature radius that is smaller than a curvature radius of a curvature formed with the curving work, a difference between the curvature radiuses being equivalent to a spring back of the curved electrode plate.

The above-stated battery manufacturing method may be varied such that, when R₀ represents a maximum curvature radius of an outer surface of the separator that contacts with an inner side of the curved end, the curvature radius of the forming die is in a range from 0.15R₀ to 1.00R₀, inclusive.

The curving work performed to satisfy the above-described relationship produces a prominent effect of restricting the occurrence of popping-away phenomenon at the end of the electrode plate, and causes the electrode assembly to be housed into the outer package in a more reliable manner.

The above-stated battery manufacturing method may be varied such that, in the curving step, the curving work is performed by giving a pressure to the end in a thickness direction of the plate to be curved. The battery manufacturing method of such a structure can easily restrict the occurrence of popping-away phenomenon at the end of the electrode plate.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings:

FIG. 1 is a cross-sectional view showing ends of electrode plates 91 and 92 in a conventional electrode assembly 90;

FIG. 2A is a development perspective view schematically showing the positive electrode plate prototype 110 that is manufactured as an intermediate prototype in the battery manufacturing process of the embodiment;

FIG. 2B is a perspective view schematically showing the positive electrode plate 11 used in the battery manufacturing process of the embodiment;

FIG. 3A is a cross-sectional view schematically showing a process in which the curving work is performed onto the end 110b of the positive electrode plate prototype 110;

FIG. 3B is a cross-sectional view schematically showing a process in which the curving work is performed onto the end 110b of the positive electrode plate prototype 110;

FIG. 3C is a cross-sectional view schematically showing a process in which the curving work is performed onto the end 110b of the positive electrode plate prototype 110 in the battery manufacturing process of the embodiment;

FIG. 3D is a cross-sectional view schematically showing the end 11b of the positive electrode plate 11 having been manufactured through the curving work;

FIG. 4A is a perspective view schematically showing a process in which the positive electrode plate 11 and the negative electrode plate 12 are wound together with the separator 13 sandwiched there between;

FIG. 4B is a perspective view schematically showing the manufactured electrode assembly 10;

FIG. 5 is a perspective view schematically showing a process in which the electrode assembly 10 is inserted into the outer package 30, and then the outer package 30 is sealed with the cap assembly 40;

FIG. 6 is a cross-sectional view showing the end 11b of the positive electrode plate 11 in the electrode assembly 10 of the embodiment;

FIG. 7 is a cross-sectional view schematically showing a process in which the curving work is performed onto an end of an electrode plate by the battery manufacturing method of Modification 1;

FIG. 8A is a cross-sectional view schematically showing a process in which the curving work is performed onto an end of an electrode plate by the battery manufacturing method of Modification 2; and

FIG. 8B is a cross-sectional view schematically showing a process in which the curving work is performed onto an end of an electrode plate by the battery manufacturing method of Modification 2.

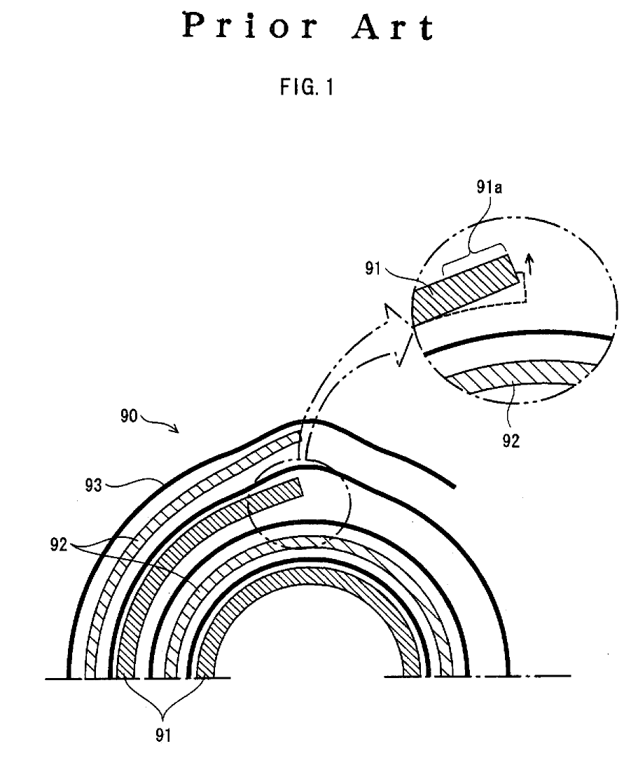

### DESCRIPTION OF THE PREFERRED EMBODIMENT

The following describes a preferred embodiment of the present invention, with reference to the attached drawings. It should be noted here that the specific example described in the following is provided to explain, in an understand able way, the structure of the present invention and the acts and effects produced by the structure. The present invention is not limited to any portions of the specific example, except for the characteristic structural elements of the invention.

### Embodiment

1. Manufacturing Positive Electrode Plate 11

First, a positive electrode mixture agent is generated by adding appropriate amounts of conductive agent (graphite or the like) and bonding agent (polytetrafluoroethylene or the like) to manganese dioxide, which is to be the active material, and mixing them.

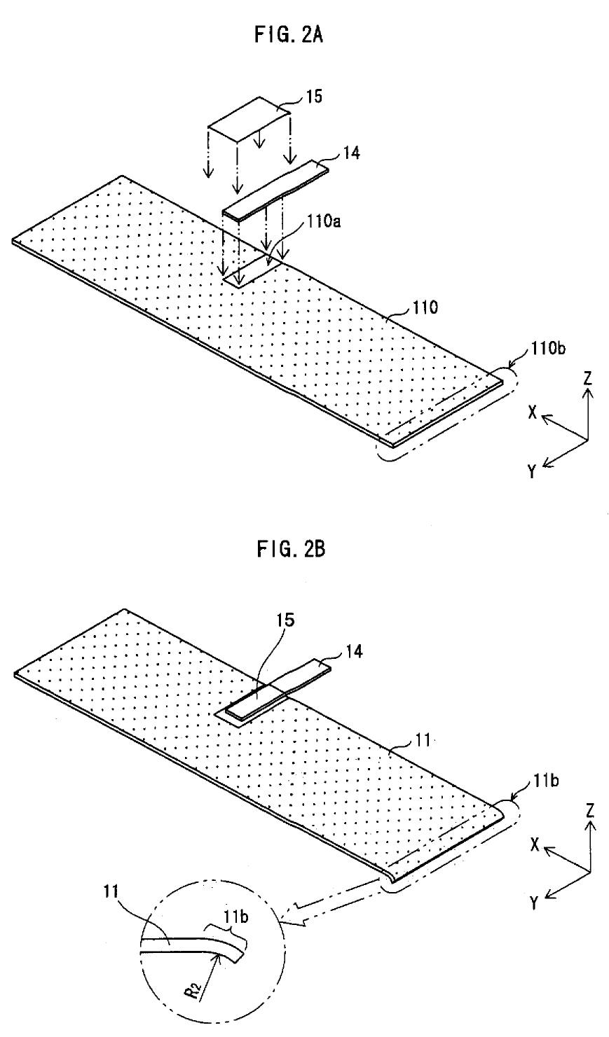

Then, the positive electrode mixture agent that was generated in this way is applied to two major surfaces of a punching metal made of stainless, and said punching metal with the mixture agent is pressed to improve the density of the mixture agent. After this, the punching metal is cut into pieces having a predetermined measurement, and the punching metal pieces are dried. Each piece of punching metal generated in this way is used as a positive electrode plate prototype 110 (see FIG. 2A).

Next, as shown in FIG. 2A, the active material is partially removed from the positive electrode plate prototype 110 such that the punching metal is exposed (area 110a). A positive electrode tab 14 is bonded with the area 110a by the spot welding or the like. The positive electrode tab 14 bonded with the area 110a is covered with insulating tape 15.

The measurement of the positive electrode plate prototype 110 is, for example, as follows.

Length (X direction): 130.0 [mm]

Width (Y direction): 38.0 [mm]

Thickness (Z direction): 0.67 [mm] to 0.72[mm]

The positive electrode plate prototype 110 is filled with the positive electrode material, with density of 3.3 [g/cm³].

Next, an end 110b of the positive electrode plate prototype 110 is curved by a curving work to have a predetermined curvature radius. The curving work provides a positive electrode plate 11 whose end 11b has been curved to have curvature radius R₂.

It should be noted here that the curving work is performed such that substantially the entire length of the end 11b of the positive electrode plate 11 has the curvature radius R₂ uniformly, and that the curvature produced by the curving work is different from a curvature that is produced when, for example, an electrode plate is cut by a shear force in a conventional manufacturing process.

2. Work on the End 11b of Positive Electrode Plate 11

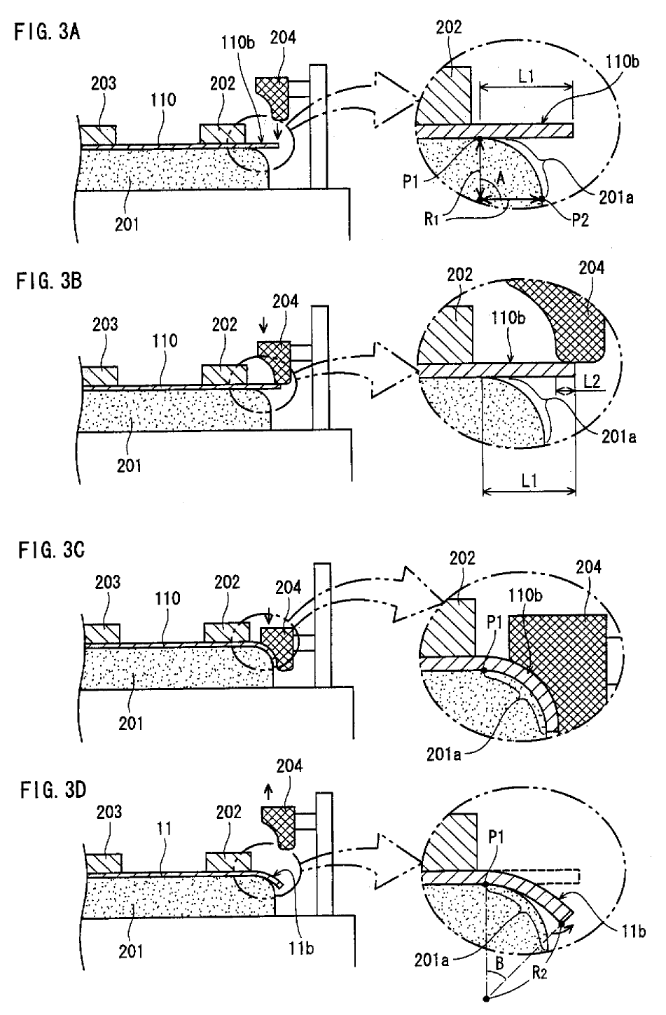

The curving work of the end 11b that is performed when the positive electrode plate 11 is produced will be described in detail with reference to FIGS. 3A through 3D.

As shown in FIG. 3A, first the positive electrode plate prototype 110 is placed on a fixed forming die 201. Then, the positive electrode plate prototype 110 is fixed to the forming die 201 by pressure given thereto via fixing guides 202 and 203. The forming die 201 includes an end 201a (herein after referred to as “forming curved part”) that has been worked into curved shape. The positive electrode plate prototype 110 is placed on the fixed forming die 201 such that an end 110b extends over the forming curved part 201a. It should be noted here that the end 110b corresponds to the end 11b shown in FIG. 2B.

As shown in FIG. 3A, a length L1 of a portion of the end 110b actually extending over the forming curved part 201a corresponds to a circumferential length of a curved portion that is created by the curving work.

Next, as shown in FIG. 3B, a pressing head 204 is lowered onto the end 110b of the positive electrode plate prototype 110. The pressing head 204 has a curved part (herein after referred to as “pressing curved part”) that corresponds to the forming curved part 201a of the forming die 201. The pressing head 204 can be adjusted in position such that it is placed directly above the end 110b of the positive electrode plate prototype 110. As the pressing head 204 is lowered, it contacts with the edge of the end 110b of the positive electrode plate prototype 110.

As shown in FIG. 3C, when the pressing head 204 is further lowered, the pressing curved part of the pressing head 204 fits firmly on the forming curved part 201a of the forming die 201 with the positive electrode plate prototype 110 sandwiched by them. With this state of firm fitting, the positive electrode plate prototype 110 is worked to have a curvature along the forming curved part 201a of the forming die 201. It should be noted here that the positive electrode plate prototype 110 has been fixed by the fixing guides 202 and 203 before the fitting operation and no positional shifting is caused by the operation.

After this, as shown in FIG. 3D, the pressing head 204 is lifted to remove the pressure from the positive electrode plate 11. With this, the end 11b springs back a little from the forming curved part 201a by the restoring force, but never returns completely to the state (the state indicated by the dotted line in the magnification of FIG. 3D) before the pressing operation. That is to say, in the positive electrode plate 11 after the curving work is performed thereonto, the edge of the end 11b faces downward on the page, and the end 11b is curved in the shape of a circular arc. It should be noted here that the curvature radius R₂ of the end 11b after the curving work is greater than the curvature radius R₁ of the forming curved part 201a as much as the spring back. The pressing force applied to the pressing head 204 can be set appropriately such that the end 11b has an appropriate curvature radius after the pressing force is removed.

With the above-described operation, the positive electrode plate 11 shown in FIG. 2B is produced.

3. Manufacturing Negative Electrode Plate 12

A plate of lithium metal is cut into pieces having a predetermined measurement so that each piece of the lithium metal is used as a negative electrode plate 12.

The measurement of the negative electrode plate 12 is, for example, as follows.

Length: 143.0 [mm]

Width: 35.5 [mm]

Thickness: 0.34 [mm]

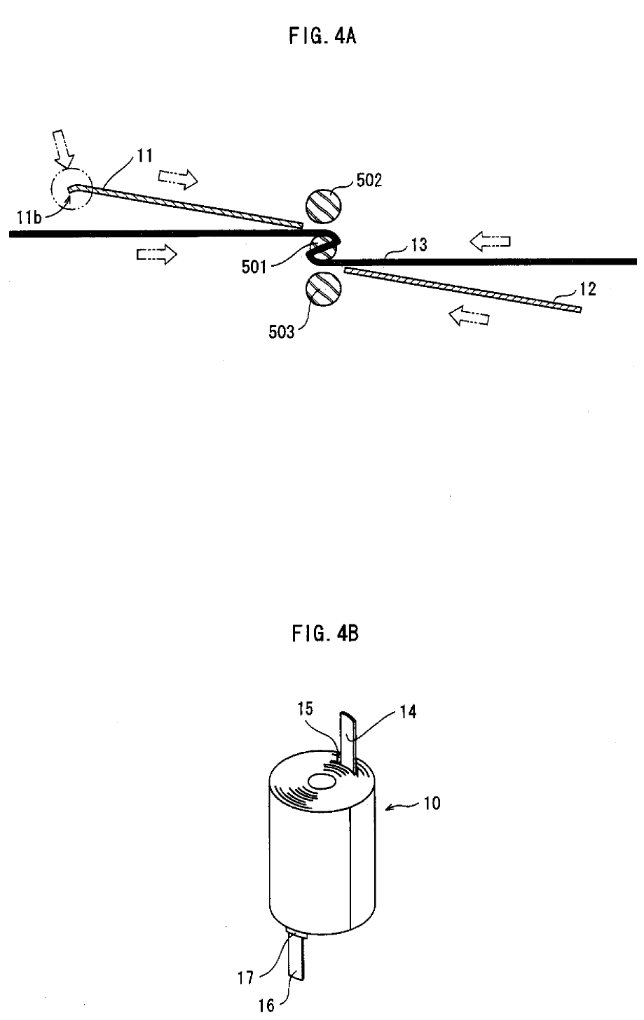

In the present embodiment, the negative electrode plate 12 is not subjected to the curving work. This is because the lithium metal constituting the negative electrode plate 12 is soft in itself and does not cause the “popping-away” phenomenon to occur even if it is not subjected to the curving work. As is the case with the positive electrode plate 11, a negative electrode tab 16 is bonded with the negative electrode plate 12 and it is covered with insulating tape 17 (see FIG. 4B).

4. Winding Work Using Positive Electrode Plate 11 and Negative Electrode Plate 12

As shown in FIG. 4A, the positive electrode plate 11 and the negative electrode plate 12, which have been generated in the above-described manner, are subjected to a winding work with a separator 13 sandwiched there between. In the winding thereof, first the separator 13 is clipped by a winding rod 501, and is wound in this state. While the separator 13 is wound, the positive electrode plate 11 is inserted between the separator 13 and a roller 502, and the negative electrode plate 12 is inserted between the separator 13 and a roller 503.

In the present embodiment, the separator 13 is made of, for example, microporous unwoven cloth made of polypropylene. The measurement of the separator 13 is, for example, as follows.

Width (Y direction): 40.0 [mm]

Thickness (Z direction): 0.05 [mm]

It should be noted here that the winding work is performed such that the end 11b of the positive electrode plate 11 that has been curved by the curving work is wound last and such that the center of curvature of the end 11b is on an internal side of the winding.

It should also be noted that, as shown in FIG. 4B, a negative electrode tab 16 has been bonded with the negative electrode plate 12 at a predetermined position thereof by the pressure bonding, and that insulating tape 17 has been attached to the negative electrode plate 12 to cover the bonded negative electrode tab 16, in a similar manner to the positive electrode plate 11.

With the above-described winding work, an electrode assembly 10 as shown in FIG. 4B is completed. As shown in FIG. 4B, the positive electrode tab 14 extends out the electrode assembly 10 upward, and the negative electrode tab 16 extends out the electrode assembly 10 downward.

It should be noted here that, although not illustrated, winding fixing tape is attached to the end of the winding on the outer circumference of the electrode assembly 10, or to the outer-most circumference of the electrode assembly 10.

5. Assembling Battery 1

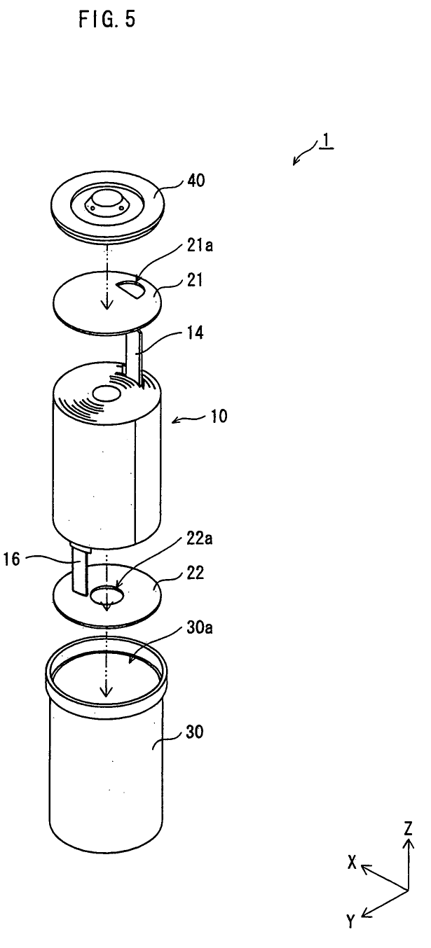

Next, as shown in FIG. 5, the electrode assembly 10 having been produced as described above is housed into an outer package 30 from an opening 30a. It should be noted here that the inner diameter of the outer package 30 is 15.80 [mm], and that the outer diameter of the electrode assembly 10 is 15.80 [mm] at the largest. Insulating plates 21 and 22 are attached to the electrode assembly 10 respectively at a top position and a bottom position thereof. The insulating plate 21 has a hole 21a so that the positive electrode tab 14 bonded with the positive electrode plate 11 passes through therein. The insulating plate 22 has a hole 22a at the center so that a welding electrode passes through therein.

The negative electrode tab 16 is bonded with the inner bottom surface of the outer package 30 while the electrode assembly 10 is housed in the outer package 30. The negative electrode tab 16 is bonded with the inner bottom surface of the outer package 30 by, for example, the resistance welding. The positive electrode tab 14 of the electrode assembly 10 passes through the hole 21a of the insulating plate 21, and is bonded with the inner surface of a cap assembly 40.

After this, nonaqueous electrolyte is filled into the outer package 30. In the outer package 30, the electrolyte permeates the electrode assembly 10. After the electrolyte has permeated the electrode assembly 10, the cap assembly 40 is placed to close the opening 30a of the outer package 30, and then the outer package 30 with the cap assembly 40 is sealed by the caulking work, laser welding or the like.

The nonaqueous electrolyte described above is produced by dissolving a solute with a solvent, where the solute is lithium trifluoromethanesulphonate occupying 0.5[mol/L] of the nonaqueous electrolyte, and the solvent contains ethylene carbonate (EC), butylenes carbonate, and 1,2-dimethoxyethane in a ratio, by volume, of 15:15:70.

6. Advantages

In the manufacturing method of the present embodiment for the battery 1, the end 11b of the positive electrode plate 11 is subjected to the curving work to have curvature radius R₂. Also, in the electrode assembly 10, the end 11b of the positive electrode plate 11 is the end of the winding and the curvature thereof curves toward an internal side of the winding.

In the battery 1 having been manufactured through the above-described steps, occurrence of the popping-away phenomenon is restricted at the end (end 11b) of the winding of the positive electrode plate 11. Accordingly, the manufacturing method of the present embodiment for the battery 1 makes it possible to manufacture the electrode assembly 10 such that it can be easily housed into the outer package 30, even if the positive electrode plate 11 and the negative electrode plate 12 are wound to be high in density.

As a result, the manufacturing method of the present embodiment can manufacture the battery 1 having a high capacity by winding the positive electrode plate 11 and the negative electrode plate 12 to be high in density, and can make the outer package 30 easy to house by restricting the outer diameter of the electrode assembly 10 to a predetermined measurement, achieving high manufacturing yield.

The length L1 of the end 11b of the positive electrode plate 11 (see FIGS. 3A and 3B) should be set to a measurement that can restrict the occurrence of the popping-away phenomenon in a reliable manner. More specifically, the length L1 of the end 11b should be larger than the thickness of the positive electrode plate 11. In the actuality, it is preferable that the length L1 is approximately 2[%] to 3[%] of the length (the length in the X direction in FIGS. 2A and 2B) of the positive electrode plate 11.

Between the curvature radius R₁ of the forming curved part 201a of the forming die 201 shown in FIG. 3A and the curvature radius R₂ of the end 11b after the curving work, there is a relationship that, the larger the curvature radius R₁ is, the larger the curvature radius R₂ is. The curvature radius R₁ is set by taking the thickness, material and the like of the positive electrode plate 11 so that the curvature radius R₂ falls within an appropriate range.

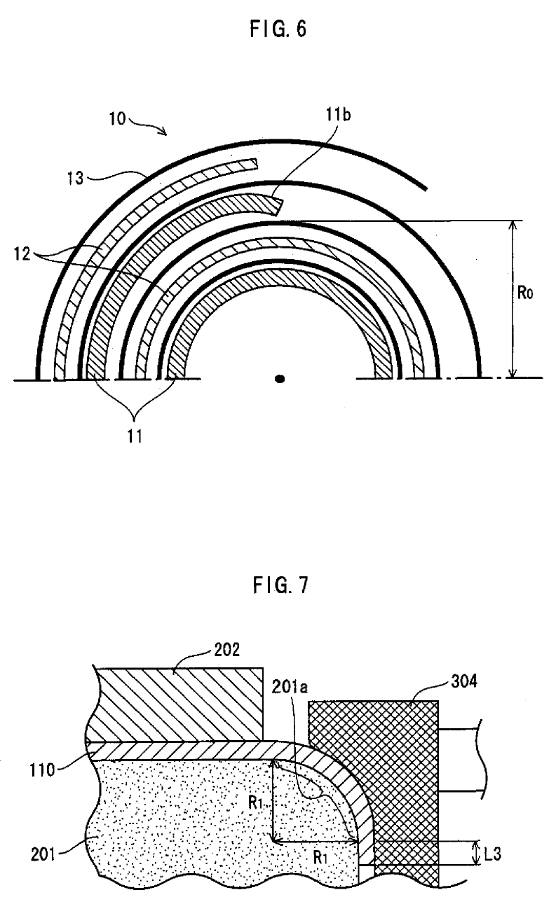

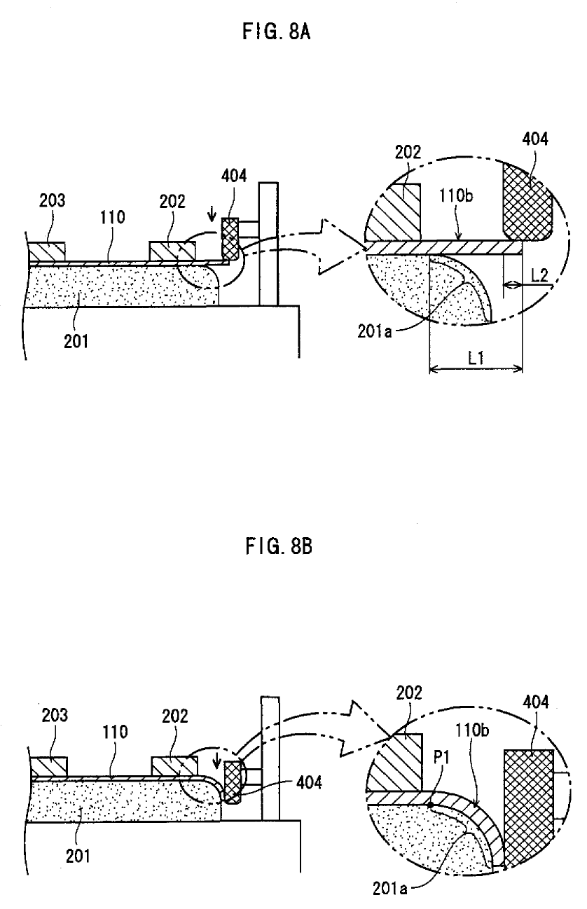

Here will be described a detailed method of setting the curvature radius R₂, with reference to FIG. 6.

When R₀ represents a curvature radius at a position where the end 11b of the positive electrode plate 11 contacts with the separator 13 of the electrode assembly 10, it is preferable to set the curvature radius R₁ of the forming curved part 201a of the forming die 201 as follows.

0.15×R₀≦R₁≦1.00×R₀ [Equation 1]

When the curvature radius R₁ of the forming curved part 201a of the forming die 201 is set to be larger than (1.00×R), the effect of restricting the occurrence of the popping-away phenomenon becomes smaller. It is understood from this that it is preferable that the relationship (R₁≦1.00×R₀) is satisfied.

On the other hand, when the curvature radius R₁ is set to be smaller than (0.15×R₀), the end 11b is curved to be like a protrusion of the electrode assembly 10 by the curving work. This is not preferable since the end 11b curved as such becomes a hindrance when the electrode assembly 10 is inserted into the outer package 30, and since the edge of the end 11b strongly contacts with the separator 13 or the negative electrode plate 12 and may defect them. For these reasons, it is preferable that the curvature radius R₁ of the forming curved part 201a of the forming die 201 is set so that [Equation 1] indicated above is satisfied.

7. Verification Experiment

The following will verify the above-stated preference that the curvature radius R₁ of the forming curved part 201a of the forming die 201 is set so that [Equation 1] indicated above is satisfied.

First, Invention Examples 1-4 and Comparative Examples 1-2 were prepared, where these examples were manufactured under the same condition except for the form of the curving work to which the end 11b of the positive electrode plate 11 is subjected. The examples were manufactured in approximately the same manner as the present embodiment.

### Invention Example 1

The end 11b of the positive electrode plate 11 was subjected to the curving work by setting the curvature radius R₁ of the forming curved part 201a of the forming die 201 to (0.05×R₀).

### Invention Example 2

The end 11b of the positive electrode plate 11 was subjected to the curving work by setting the curvature radius R₁ of the forming curved part 201a of the forming die 201 to (0.10×R₀).

### Invention Example 3

The end 11b of the positive electrode plate 11 was subjected to the curving work by setting the curvature radius R₁ of the forming curved part 201a of the forming die 201 to (0.15×R₀).

### Invention Example 4

The end 11b of the positive electrode plate 11 was subjected to the curving work by setting the curvature radius R₁ of the forming curved part 201a of the forming die 201 to (1.00×R₀).

### Comparative Example 1

The end of the positive electrode plate was not subjected to the curving work.

### Comparative Example 2

The end of the positive electrode plate was bent at a right angle.

Then, 10 electrode assembly samples per example were manufactured, each electrode assembly sample using the positive electrode plate of each of Invention Examples 1-4 and Comparative Examples 1-2. The manufactured electrode assembly samples were tried to be housed into the outer package 30. The outer package 30 whose internal diameter is 15.80 [mm] was used for the experiment. Table 1 shown below shows the results of how many electrode assembly samples were housed into the outer package 30. Table 1 also shows the outer diameters of the electrode assembly 10 electrode assembly samples manufactured using the positive electrode plate of each of Invention Examples 1-4 and Comparative Invention Examples 1-2, which were measured before the electrode assembly samples were housed into the outer package 30.

TABLE 1

| | | | Electrode | Electrode |
|---|---|---|---|---|
| | | | Assembly | Assembly |
| | Work Applied to | | Outer | Insertion |
| | Electrode Plate | Curvature | Diameter | Success |
| | End | Radius R₁ | (mm) | Rate |
| Invention | Curving Work | 0.05 × R₀ | 15.60 to 15.90 | 5/10 |
| Example 1 | | | | |
| Invention | Curving Work | 0.10 × R₀ | 15.50 to 15.80 | 9/10 |
| Example 2 | | | | |
| Invention | Curving Work | 0.15 × R₀ | 15.35 to 15.65 | 10/10 |
| Example 3 | | | | |
| Invention | Curving Work | 1.00 × R₀ | 15.20 to 15.50 | 10/10 |
| Example 4 | | | | |
| Comparative | No Bending | — | 15.95 to 16.25 | — |
| Example 1 | Work | | | |
| Comparative | Bending at a | — | 15.90 to 16.20 | 0/10 |
| Example 2 | right Angle | | | |

As shown in Table 1, the outer diameter of the electrode assembly of Comparative Example 1 is larger than those of Invention Examples 1-4 and Comparative Example 2. It is thought that this is because the end of the positive electrode plate has not been curved or bent. Namely, in the electrode assembly of Comparative Example 1, once the external force having been applied thereto in the winding work is removed, the restoring force acts upon the end of the positive electrode plate and makes the end pop away.

The electrode assembly of Comparative Example 2 could not be inserted into the outer package too. It is thought that this is because the end of the positive electrode plate had been bent at a right angle, the shape of the end was still distorted even after the electrode assembly was completed. That is to say, it is thought that, when the end of the positive electrode plate is bent at a right angle, the shape of the end does not fit with the internal wall of the outer package even after the electrode assembly is completed. Especially, it was observed with respect to Comparative Example 2 that the end of the positive electrode plate having been bent at a right angle remained as a protrusion in the electrode assembly even after the winding was completed, increasing the outer diameter of the electrode assembly. It is understood from this result that bending the end of the electrode plate at a right angle is not preferable.

With regard to insertion of the electrode assembly into the outer package, as Table 1 shows, Invention Examples 1-4 had better success rate than Comparative Examples 1-2. It also shows that Invention Example 4 had the smallest outer diameter of the electrode assembly, followed by Invention Example 3, Invention Example 2, and Invention Example 1 in this order. All the samples of Invention Examples 3 and 4 could be inserted into the outer package.

On the other hand, with respect to Invention Example 2, nine out of ten samples were able to be inserted into the outer package, and with respect to Invention Example 1, five out of ten samples were able to be inserted into the outer package.

Reviewing the results of the experiment in an integrated manner, it is preferable that the curvature radius R₁ of the forming curved part 201a of the forming die 201 is set so that [Equation 1] indicated above is satisfied.

Meanwhile, in the present embodiment, the end 11b of the positive electrode plate 11 is subjected to the curving work before the electrode assembly 10 is formed. This is because it is difficult to perform the curving work onto the end 11b during the winding work. Also, according to the present embodiment, since the stiffness of the negative electrode plate 12 or the separator 13 is lower than the positive electrode plate 11, it is difficult to curve only the end 11b during the winding work, and it is difficult to adjust the stress of the winding itself. In contrast, when only the end 11b of the positive electrode plate 11 is subjected to the curving work before the winding work is performed, it is possible to restrict the occurrence of the popping-away phenomenon at the end of the winding, even during the manufacturing of the electrode assembly 10.

As described above, in the case where the electrode assembly 10 is manufactured using an electrode plate that is strong in stiffness and is not curving (the positive electrode plate 11 in the present embodiment), it is possible to obtain the electrode assembly 10 that can be housed into the outer package 30 in an excellent manner by subjecting the end 11b to the curving work to have a certain curvature before the winding work is performed. And thus, the manufacturing method of the present embodiment for the battery 1 can manufacture, with a high manufacturing yield, the battery 1 having high energy density.

### <Modification 1>

Modification 1 on the battery manufacturing method will be described with reference to FIG. 7. This modification on the battery manufacturing method is the same as the above-described embodiment except for the method of the curving work to which an end of an electrode plate is subjected.

As shown in FIG. 7, the curving work of the present modification is characterized by the use of a pressing head 304 that is longer downward on the page of FIG. 7 than the pressing head 204 of the embodiment. With use of such pressing head 304, it is possible to perform the curving work onto an end that is longer (by length L3 shown in FIG. 7) than the end processed by the above-described embodiment.

### <Modification 2>

In the above-described embodiment and Modification 1, the pressing heads 204 and 304 have shapes that enable them to fit firmly on the forming curved part 201a of the forming die 201, while a pressing head 404 used in the curving work performed onto the end 11b in the present modification does not have a curving shape corresponding to the shape of the forming curved part 201a. As shown in FIG. 5B, when the pressing head 404 with such a shape is used, it is required that the pressing head 404 acts such that the end 110b of the positive electrode plate prototype 110 is entirely pressed onto the forming curved part 201a of the forming die 201 without a gap therebetween.

### <Others>

In the curving work of the battery manufacturing method of the above-described embodiment, the forming die 201 including the forming curved part 201a having a single curvature is used. However, the forming curved part 201a of the forming die 201 does not necessarily have a single curvature, but may have two or more curvatures. Namely, a forming die including a curved part that has a plurality of curvatures may be used for the curving work.

Also, in the curving work, the end of the electrode plate may be bent, instead of being curved. For example, the end of the electrode plate may be bent at an angle of more than 90 degrees. In this case, however, it is not preferable to bend the end at a right angle or at an angle closer to right angle because it may be an obstacle to the insertion of the electrode assembly into the outer package, as the above-described verification indicates.

Also, in the above-described embodiment, part of the end 11b of the positive electrode plate 11 is pressed in the curving work. However, not limited to this, all the end 11b may be pressed in the curving work, depending on, for example, the shape of the pressing surface of the pressing head.

Also, the length L1 of the end 110b of the positive electrode plate prototype 110 may be varied as necessary depending on, for example, the size of the electrode assembly 10 or the size of the electrode plates 11 and 12 to be manufactured.

Further, as described in the embodiment above, it is preferable that the curving work is performed after an electrode plate, whose core is filled with an active material, is produced. However, the active material may be filled after the curving work is performed. In this case, however, filling the active material is cumbersome and complicated. Also, the curving work is performed after tabs are bonded with electrode plates.

Further, in the above-described embodiment, as one example, the pressing method is used in the curving work. However, the end may be pulled in a certain direction so that the edge of the end faces toward the internal side of the winding. Further, by taking into the account the stiffness of the electrode plate, the end of the negative electrode plate may be subjected to the curving work, or ends of both of the positive and negative electrode plates may be subjected to the curving work.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. A manufacturing method for a battery, comprising the steps of:
preparing a positive electrode plate and a negative electrode plate which are both belt-like;
performing a curving work onto an end of at least one of the positive electrode plate and the negative electrode plate so that the end has a curvature, the end being located in a longitudinal direction of the plate; and
after performing the curving work, performing a winding work by winding the positive electrode plate and the negative electrode plate with a separator there between all together to produce an electrode assembly, wherein
in the winding step, the winding work is performed such that the end having the curvature is wound last in the winding work and such that the curvature curves toward an internal side of the electrode assembly.

2. The battery manufacturing method of claim 1, wherein
in the electrode plate preparing step, an electrode plate whose core part is filled with an active material is prepared as the positive electrode plate, and
in the curving step, the curving work is performed onto an end of the positive electrode plate.

3. The battery manufacturing method of claim 1, wherein
a forming die used in the curving step has a curvature radius that is smaller than a curvature radius of a curvature formed with the curving work, a difference between the curvature radiuses being equivalent to a spring back of the curved electrode plate.

4. The battery manufacturing method of claim 3, wherein
when R₀ represents a maximum curvature radius of an outer surface of the separator that contacts with an inner side of the curved end,
the curvature radius of the forming die is in a range from 0.15R₀ to 1.00R₀, inclusive.

5. The battery manufacturing method of claim 1, wherein
in the curving step, the curving work is performed by giving a pressure to the end in a thickness direction of the plate to be curved.

6. The battery manufacturing method of claim 1 further comprising the step of
housing the electrode assembly and nonaqueous electrolyte together into an outer package that is in a shape of a cylinder having a bottom.
